(19) United States
(12) Patent Application Publication
(10) Pub. No.: US 2023/0130362 A1
(43) Pub. Date: Apr. 27, 2023

(54) DEVICE AND METHOD FOR AUTOMATICALLY GENERATING ELECTRONIC DRAWINGS, AND NON-TRANSITORY COMPUTER-READABLE MEDIUM HAVING RECORDED THEREON COMPUTER PROGRAM FOR EXECUTING THE METHOD

(71) Applicant: Samsung Engineering Co., Ltd., Gangdong-gu (KR)

(72) Inventors: Gyun Ho HA, Gangdong-gu (KR); Hong Yun KIM, Gangdong-gu (KR); Young Jun HONG, Gangdong-gu (KR); Ho Sung RYOO, Gangdong-gu (KR); Young Ki MOON, Gangdong-gu (KR); Sang Hyuk PARK, Gangdong-gu (KR); Jong Wook KIM, Gangdong-gu (KR); Geun Yong CHOI, Gangdong-gu (KR); Young Min PARK, Gangdong-gu (KR); Jee Seok KIM, Gangdong-gu (KR); Ji Yoon HYUN, Gangdong-gu (KR); Hyeon Bae JANG, Gangdong-gu (KR)

(21) Appl. No.: 17/861,941

(22) Filed: Jul. 11, 2022

(30) Foreign Application Priority Data
Oct. 27, 2021 (KR) 10-2021-0144969

(51) Int. Cl. G06F 30/20

(52) U.S. Cl. CPC G06F 30/20

(57) ABSTRACT

An electronic drawing generating device may validate loaded strength calculation data, nozzle data, and firefighting data, and may generate a preview display based on an engineering data sheet generated based on the validated data. When there is an error in the preview, the engineering data may be corrected and electronic drawings may be automatically generated.

### CROSS-REFERENCE TO RELATED APPLICATION

This application is based on and claims priority under 35 U.S.C. § 119 to Korean Patent Application No. 10-2021-0144969, filed on Oct. 27, 2021, in the Korean Intellectual Property Office, the disclosure of which is incorporated by reference herein in its entirety.

### BACKGROUND

### 1. Field

The present invention relates to a method of automatically generating an electronic drawing by using strength calculation data.

### 2. Description of the Related Art

In the related art, users check data about strength calculation results obtained using a strength calculation program and then manually generate drawings by using a drawing tool of an AutoCAD program by manually inputting the data piece by piece into the AutoCAD program.

### PRIOR ART

### Patent Document

(Patent Document 1) KR 10-1757451 B1
(Patent Document 2) KR 10-2009-0036354 B1
(Patent Document 3) KR 10-2013-0066356 B1

### SUMMARY

One or more embodiments include a method of automatically generating electronic drawings of a shape of a tank by using strength calculation data, nozzle data, and other related data.

Additional aspects will be set forth in part in the description which follows and, in part, will be apparent from the description, or may be learned by practice of the presented embodiments of the disclosure.

According to one or more embodiments, a method of generating an electronic drawing includes: extracting, by a preprocessing unit, design data necessary for preparing drawings of a tank from strength calculation data about the tank provided by a strength calculation program, converting, by the preprocessing unit, the extracted design data according to a given rule or reference, and generating, by the preprocessing unit, strength calculation data having a preset format; loading, by a loading unit, at least one of the strength calculation data having a preset format, firefighting data, and nozzle data; validating, by a validation unit, the strength calculation data having a preset format, the firefighting data, and the nozzle data; generating, by an engineering data generating unit, engineering data by using the strength calculation data having a preset format, the firefighting data, and the nozzle data;

providing, by a viewer, a preview of drawings of items constituting the tank based on the engineering data; and determining, by a controller, whether an error occurs in the preview, and when it is determined that an error occurred in the preview, performing validation or editing of the engineering data, and when it is determined that no error occurred in the preview, generating, by an electronic drawing generating unit, electronic drawings of items constituting the tank.

In an embodiment, the loading unit may include a first loading unit configured to load only the strength calculation data having a preset format, wherein, when the first loading unit is activated and the strength calculation data having a preset format is loaded, the validation unit may be further configured to automatically validate the strength calculation data having a preset format.

In an embodiment, in the providing of the preview, a preview generating interface may be activated only after the strength calculation data having a preset format, the firefighting data, and the nozzle data are loaded and the engineering data is generated, and when the preview generating interface is activated, the preview of the drawings of the tank may be provided.

In an embodiment, a display unit may be configured to provide a preview generating interface, and the preview may be provided when the preview generating interface is activated, and the controller may be further configured to determine whether an error occurred by checking an interference, placement, and scale between the nozzle, structure, and plates of the preview.

In an embodiment, the validation unit may be further configured to validate blank items, a tank implementation range, and tank retention data.

In an embodiment, the validation unit may be further configured to validate a radius and a height of a nozzle based on the nozzle data.

In an embodiment, the viewer may include: a drawing list displaying a list of drawings of the items constituting the tank when a preview generating interface is activated; and a shape display section displaying shapes of the items selected from the drawing list.

In an embodiment, the engineering data generating unit may be further configured to generate the engineering data and store the engineering data in an engineering data file having a first format, and the engineering data file may include a plurality of sheets of preset items.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 and 2 illustrate internal configurations of an electronic drawing generating device according to an embodiment;

FIGS. 3 and 5 illustrate examples of generating engineering data according to an embodiment;

FIG. 4 illustrates an example of loading nozzle data according to an embodiment;

FIG. 6 illustrates an example of a strength calculation data validation unit according to an embodiment;

FIG. 7 illustrates an example of a data editing unit according to an embodiment;

FIG. 8 illustrates an example of an important data validation unit according an embodiment;

FIGS. 9 and 10 illustrate an example of an engineering data sheet according to an embodiment;

FIG. 11 illustrates an example of a preview generating interface being activated to provide a preview, according to an embodiment; and

FIG. 12 is a flowchart illustrating a method of generating electronic drawings, according an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described with reference to the accompanying drawings so that those of ordinary skill in the related art may clearly understand the scope of the present disclosure and may easily implement the idea of the present disclosure.

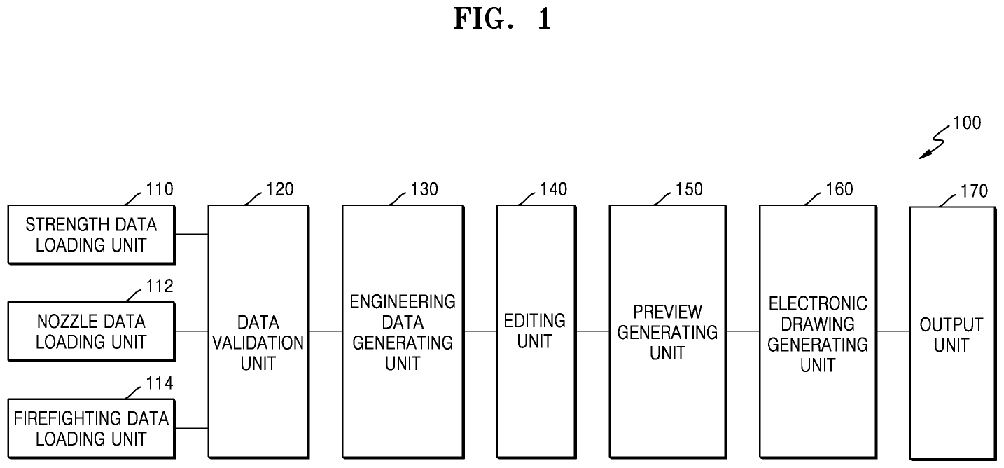

FIG. 1 illustrates an internal configuration of an electronic drawing generating device according to an embodiment. The electronic drawing generating device 100 includes a processor and a display, and a device capable of running applications or programs. The electronic drawing generating device 100 is described based on generating an electronic drawing of a tank in the present specification. However, electronic drawings of a column, a vessel, etc. may be generated in a substantially similar manner.

The electronic drawing generating device 100 may include a controller (not shown), a plurality of loading units 110, 112, and 114 (hereinafter, also referred to as strength data loading unit 110, nozzle data loading unit 112, and firefighting data loading unit 114), a data validation unit 120, an engineering data generating unit 130, an editing unit 140, a preview generating unit 150, an electronic drawing generating unit 160, and an output unit 170.

According to an embodiment, the electronic drawing generating device 100 may generate engineering data in the engineering data generating unit 130 by using data received through a plurality of loading units 110, 112, and 114, validate data through the data validation unit 120 in the process of loading data before generating, after generating, or to generate engineering data, and correct an error of data through the editing unit 140. When engineering data is generated in the engineering data generating unit 130, based on the generated engineering data, an object of the tank to be drawn may be selected and a preview of an electronic drawing of the selected object may be identified through the preview generating unit 150, and when an error occurred, data may be validated through the data validation unit 120 or the error may be corrected through the editing unit 140. Thereafter, the electronic drawing generating unit 160 may be activated to generate the electronic drawing, and the electronic drawing may be output through the output unit 170 when necessary.

According to an embodiment, the controller may be implemented to control functions of the plurality of loading units 110, 112, and 114, the data validation unit 120, the engineering data generating unit 130, the editing unit 140, the preview generating unit 150, the electronic drawing generating unit 160, and the output unit 170. For example, when strength calculation data loaded from the engineering data generating unit 130 is used, the data validation unit 120 may be controlled to be automatically executed. In addition, when nozzle data loaded from the engineering data generating unit 130 is used, the data validation unit 120 may be controlled to be automatically executed to validate whether the radius and height of the loaded nozzle data is appropriate.

In addition, the controller may determine whether an error occurs in the preview generated by the preview generating unit 150, and when it is determined that an error occurred in the preview, validation or editing of the engineering data may be performed, and when it is determined that no error occurred in the preview, the controller may control the electronic drawing generating unit 160 to generate electronic drawings of items constituting the tank.

Hereinafter, each configuration will be described in more detail with reference to FIGS. 1 to 11.

According to an embodiment, the plurality of loading units 110, 112, 114 may include a strength data loading unit 110, a nozzle data loading unit 112, and a firefighting data loading unit 114.

According to an embodiment, a preprocessing unit (not shown) may extract design data necessary for preparing drawings of the tank from the strength calculation data about the tank provided by a strength calculation program, convert the extracted design data according to a given rule or reference, and generate the strength calculation data having a preset format.

The preprocessing unit (not shown) may be implemented in the electronic drawing generating device 100 or in an external terminal and may provide the strength calculation data having a preset format generated in the preprocessing unit to the electronic drawing generating device 100 through wired or wireless communication with the electronic drawing generating device 100. An example of a strength calculation program may include an AMETank program.

The preprocessing unit may extract and match data to extract only design data necessary for preparing drawings of the tank from the strength calculation data. For example, the strength calculation data may be generated by extracting data from a plurality of preset positions of a file including the strength calculation data, matching the extracted data to letters of preset positions of the strength calculation data, and extracting data value regarding the matched letters.

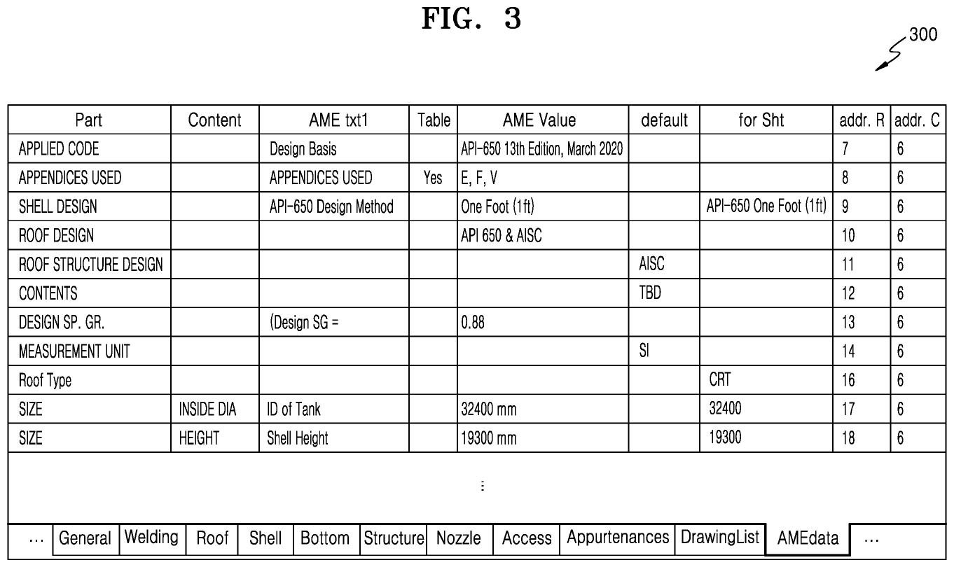

According to an embodiment, when the strength calculation data is provided in a Microsoft Word file in the AMETank program, the preprocessing unit may convert the strength calculation data to a mapping table format having a csv or xls format as in FIG. 3 by extracting and mapping only design data necessary for preparing drawings of the tank necessary in the Microsoft Word file.

FIG. 3 shows an example of generating, by the preprocessing unit, engineering data by using the strength calculation data converted to a preset mapping table format, according to an embodiment. Referring to FIG. 3, the preprocessing unit may extract the design data necessary for preparing drawings of the tank among the strength calculation data provided by the strength calculation program and convert the extracted design data according to a given rule or reference.

For example, the term “APPLIED CODE” may be extracted from a preset position among the strength calculation data, and data matching therewith such as “Design Basis” and “API-650 13th Edition, March 2020” may be mapped by being entered on the right side of a diagram. Thereafter, units appropriate for each data may be additionally mapped or notations of each data may be standardized and additionally entered on the right side to display data necessary for preparing drawings.

The strength data loading unit 110 may load strength calculation data generated by the preprocessing unit and having a preset format. An example of the strength calculation data having a preset format is described with reference to FIG. 3.

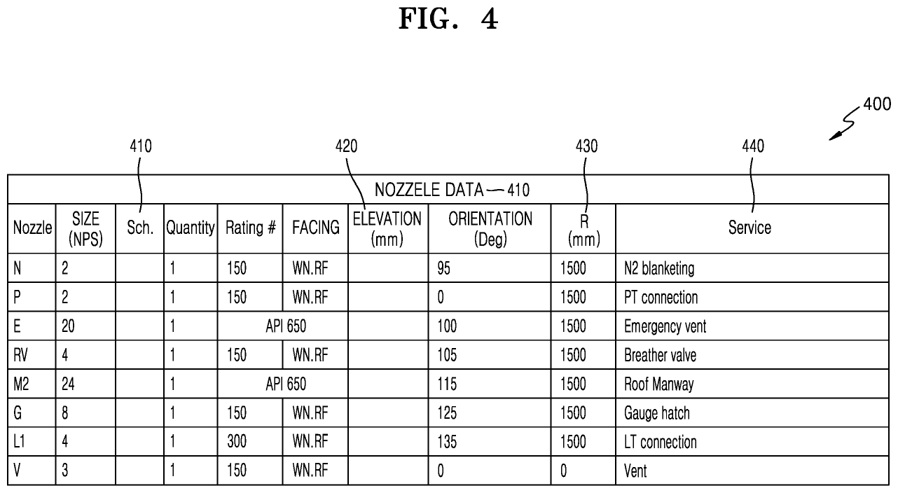

According to an embodiment, the nozzle data loading unit 112 may load nozzle data. An example of nozzle data 400 is described with reference to FIG. 4. When generating an engineering data sheet, when a value of a schedule 410 of the nozzle data is blank, a preset value may be applied. In addition, an elevation 420 value of the nozzle data may be automatically calculated according to a radius value R of the nozzle. In addition, when generating the engineering data sheet, a nozzle type may be automatically generated based on a service 440 or remark (not shown) value of the nozzle data.

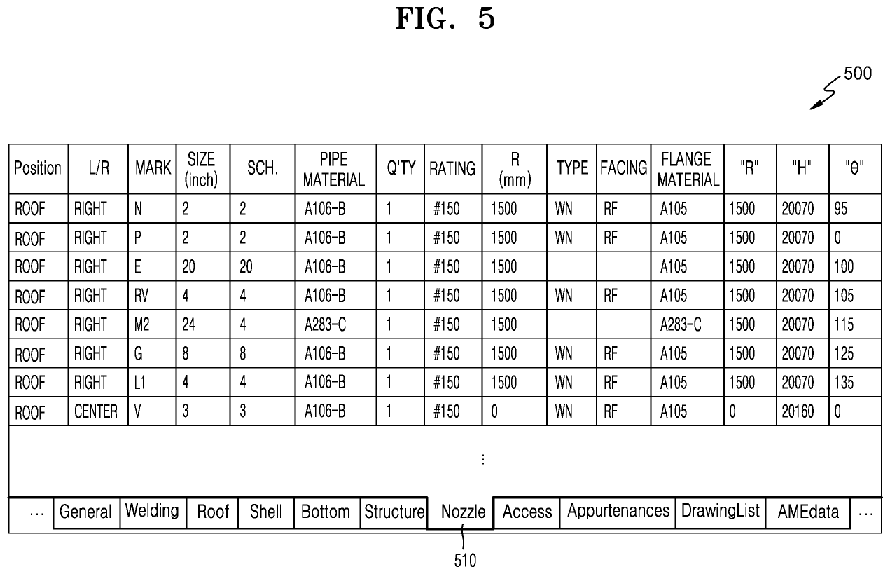

FIG. 5 shows an example of generating an engineering data sheet 500 based on loading data loaded by the nozzle data loading unit 112. The engineering data generating unit 130 (refer to FIG. 1) may generate a nozzle data sheet 510 or the like based on the nozzle data 400 loaded from the nozzle data loading unit 112. When the nozzle data is loaded from the engineering data generating unit 130 (refer to FIG. 1), the controller may check through the data validation unit 120 (refer to FIG. 1) whether an error occurs in the radius, height, etc. of the loaded nozzle data. When an error occurs, the engineering data may be generated after error correction is performed. For example, a pipe material and a flange material of a nozzle data sheet may be determined automatically based on a material around the nozzle.

The firefighting data loading unit 114 may load data related to firefighting.

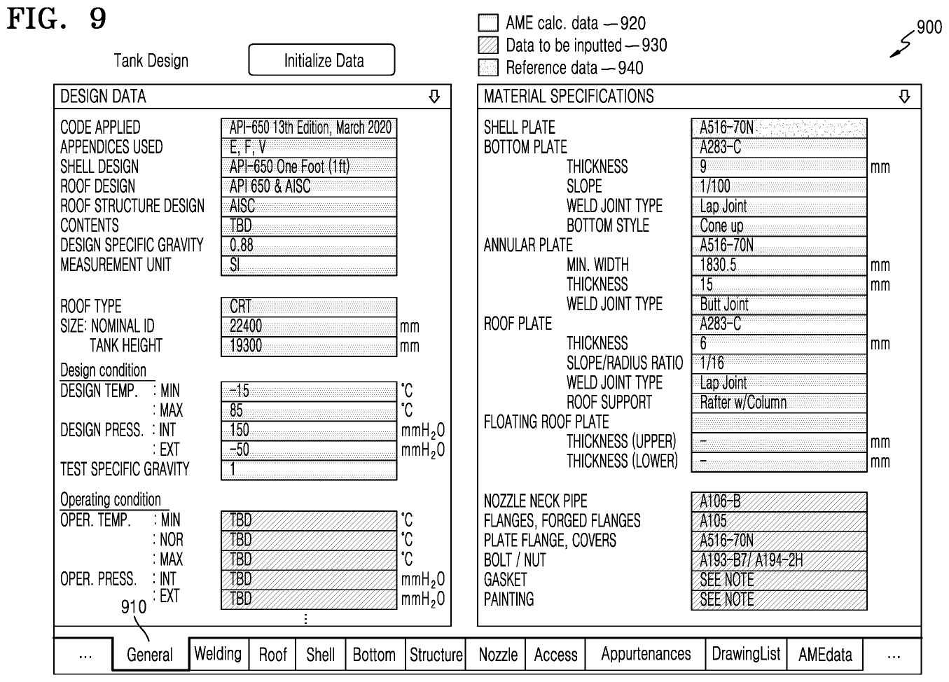

The engineering data generating unit 130 may generate the engineering data based on data loaded from the plurality of loading units 110, 112, and 114, and the engineering data may be stored in the format of an engineering data sheet. The format of the engineering data sheet may be xls, csv, or the like. FIG. 9 illustrates an example of an engineering data sheet 900. An engineering data sheet 900 may include general information, welding information, roof information, shell information, bottom information, structure information, nozzle information, access information, appurtenance information, drawing list information, and strength calculation data information (AMEdata) sheets.

The engineering data generating unit 130 may generate the engineering data sheet by sequentially loading data having different forms from each other. According to an embodiment, the engineering data generating unit 130 may load and then enter the strength calculation data having a preset format to a position of the engineering data sheet where the strength calculation data is necessary. Thereafter, the engineering data generating unit 130 may load and then enter the nozzle data or the firefighting data to a position of the engineering data sheet where the nozzle data or the firefighting data is necessary.

Referring to FIG. 9, the engineering data generating unit 130 may record the loaded strength calculation data having a preset format in a position of a general information sheet 910 where an input of the strength calculation data is necessary. Thereafter, loaded data value to be input 930 and loaded related data 940 may be sequentially brought to a position requiring input thereof to generate the general information sheet 910 constituting the engineering data sheet 900. The related data 940 may include, for example, firefighting data, and flange data that is automatically determined by the material around the nozzle.

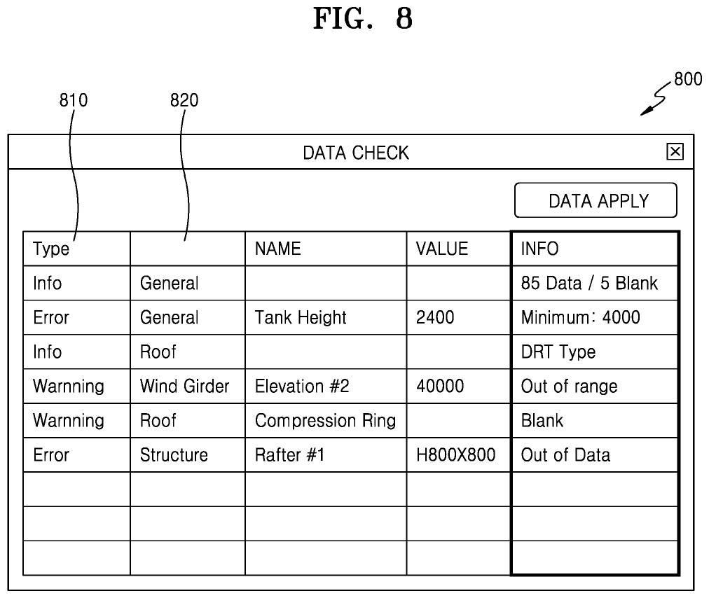

In this manner, the engineering data generating unit 130 may generate engineering data, and the generated engineering data may be validated through the data validation unit 120 (refer to FIG. 1). An example of validating data is further described with reference to FIG. 8.

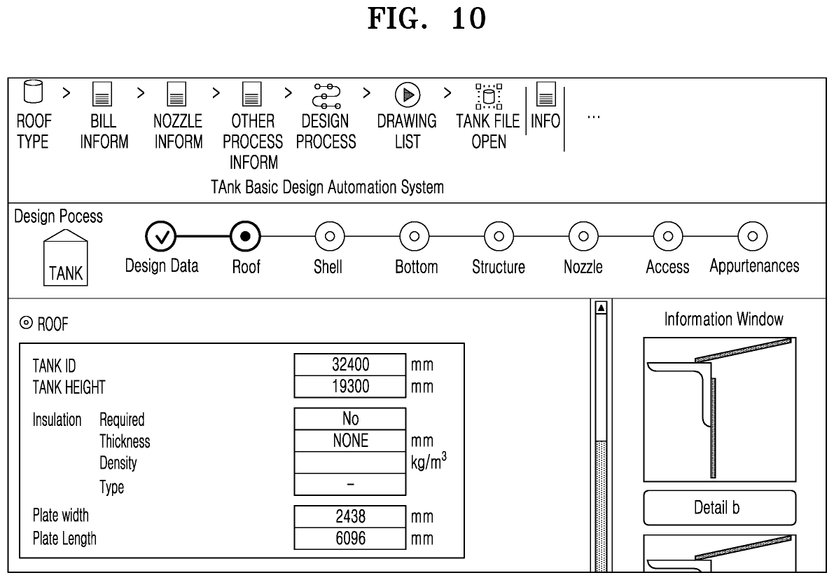

According to one or more embodiments, the engineering data generating unit 130 may sequentially load data necessary for preparing drawings of the tanks, as shown in the embodiment of FIG. 10, to generate the engineering data. For example, in case of generating a roof type tank, the engineering data may be generated in order of loading the strength calculation data and the nozzle data, loading other processing data such as firefighting data, generating sheets in the order of roof, shell, bottom, structure, nozzle, access, and appurtenances by using the loaded data, and integrating previously stored drawing list files.

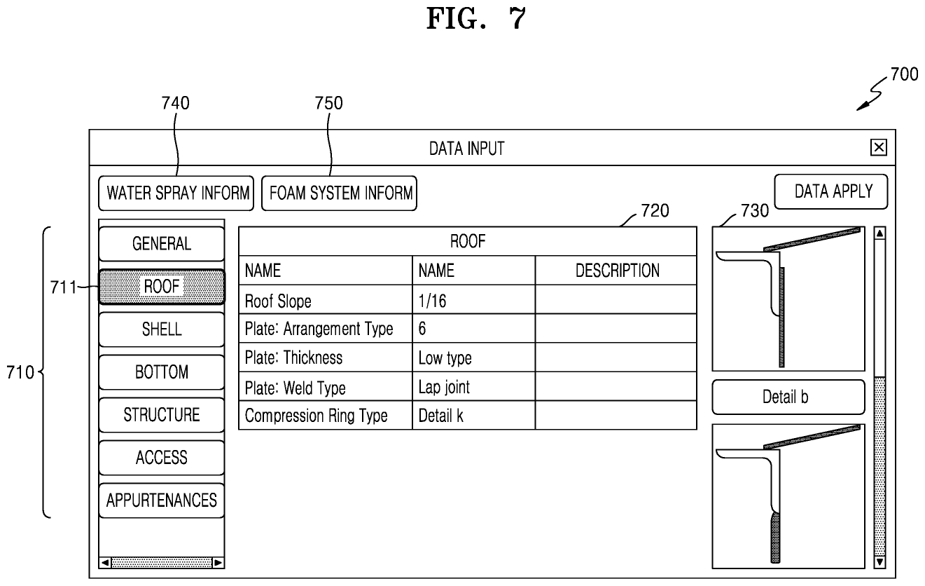

According to an embodiment, when the engineering data generating unit 130 stores the engineering data sheet after generating the engineering data, the engineering data generating unit 130 may provide a data editing unit 700 (refer to FIG. 7) capable of performing provision and correction of information about important and frequently used data among the engineering data. The user may identify or correct the engineering data through the data editing unit 700 (refer to FIG. 7) without opening the engineering data sheet.

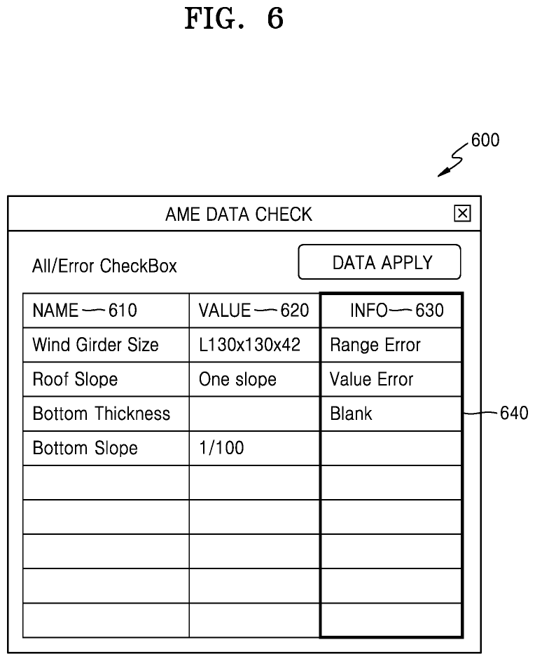

According to an embodiment, when the engineering data generating unit 130 loads the strength calculation data having a preset format, the data validation unit 120 is automatically activated and validates the loaded strength calculation data having a preset format. An example of validating the strength calculation data is described with reference to FIG. 6. When no error occurred in the strength calculation data as a result of the validation, the strength calculation data may be used to generate the engineering data. When an error occurred in the strength calculation data as a result of the validation, the strength calculation data may be corrected through the editing unit 140 (refer to FIG. 1).

According to an embodiment, the data validation unit 120 may include a strength calculation data validation unit 600 (refer to FIG. 6), a nozzle data validation unit (not shown), and an important data validation unit 800 (refer to FIG. 8).

FIG. 6 shows the strength calculation data validation unit 600 according to an embodiment as an example of the data validation unit.

The strength calculation data validation unit 600 may provide a table 640 providing item names 610, values 620 matched to the items, and information 630 about the validity of the values matched to the items.

The information 630 about the validity of the value 620 of the name 610 of the item constituting the tank and the validity of a range may be provided. Also, it is validated whether the value 620 that is necessary is left empty. ‘Range Error’ indicates a value being out of range, ‘Value Error’ indicates a value being changed, such as a character being entered instead of a number, and ‘Blank Error’ indicates a necessary value that is left empty.

FIG. 8 is shows the important data validation unit 800 according to an embodiment as an example of the data validation unit 120.

When the engineering data sheet is generated, the engineering data generating unit 130 may generate, based on the generated sheet, the data editing unit 700 (refer to FIG. 7) capable of providing and correcting frequently used data information. The important data validation unit 800 may validate data input to the data editing unit 700 (refer to FIG. 7) or corrected data.

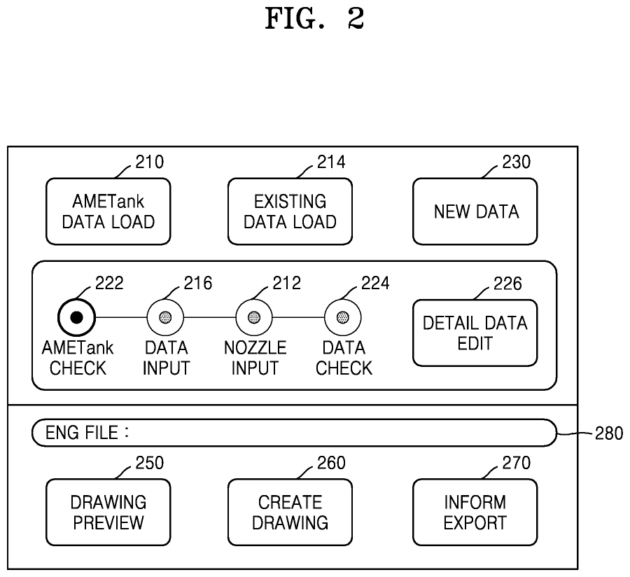

The important data validation unit 800 may provide, as a table, an error type 810, a sheet in which the error occurred 820, a name of the item in which the error occurred, and a value and information of the item in which the error occurred. For example, referring to the example of FIG. 8, an error in which a value of ‘2400’ of the ‘Tank Height’ item in the General Information sheet does not reach the minimum value of 4000 is displayed. When an error occurs, the error may be corrected through the editing unit 140 (refer to FIG. 1). The editing unit 140 (refer to FIG. 1) may be implemented in the form of a data editing unit 700 (refer to FIG. 7) or a detailed data editing unit 226 (refer to FIG. 2).

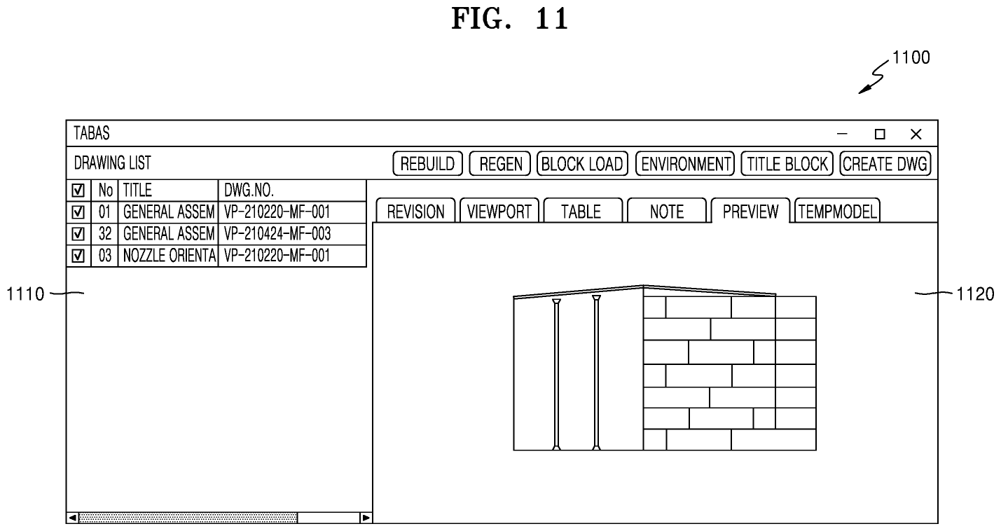

According to an embodiment, the preview generating unit 150 (refer to FIG. 1) may provide a preview of the drawings of the items constituting the tank on a viewer, based on the engineering data. The preview generating unit will be described with reference to FIG. 11. When a preview generating interface is activated, the preview generating unit may provide a preview in which a shape of the tank, nozzle list information, material specification information, and the like are displayed.

The viewer may include a split screen 1110 providing the drawing list and a shape display section 1120 displaying shapes of drawings selected from the drawing list. The drawing list indicates a list of drawings of the items constituting the tank. The viewer may provide a magnifying glass function, a partially magnifying function, a zoom function, a panning function, a ZoomFit function, and the like. The viewer may also provide a ‘REBUILD’ function for redrawing a drawing, a ‘REGENERATION’ function for expressing curves in detail, an ‘ENVIRONMENT’ function for providing information such as a layer, line, text, and block of a drawing, and a ‘CREATE DRAWING’ function for generating an electronic drawing.

The drawing list may be preset in the following form:

DRT

| DOC. NO. | DESCRIPTION |
|---|---|
| 003 | NOZZLE ORIENTATION |
| 004 | SHELL PLATE ARRANGEMENT |
| 005 | 1^{ST} COURSE SHELL PLATE |
| 006 | BOTTOM PLATE ARRANGEMENT |
| 007 | BOTTOM PLATE CUTTING PLAN |
| 008 | ROOF PLATE ARRANGEMENT |
| 009 | ROOF PLATE CUTTING PLAN |
| 010 | DETAIL OF ROOF STRUCTURE |
| 011 | DETAIL OF SHELL MANHOLE |
| 012 | DETAIL OF CLEANOUT DOOR |
| 013 | DETAIL OF ROOF MANHOLE |
| 014 | DETAIL OF NOZZLE |
| 015 | DETAIL OF WATER SPRAY SYSTEM |
| 016 | DETAIL OF AIRFORM CHAMBER |
| 017 | DETAIL OF AIRFORM CHAMBER PLATFORM |
| 018 | DETAIL OF SPIRAL STAIRWAY |
| 019 | DETAIL OF LADDER |
| 020 | DETAIL OF ROOF HANDRAIL |
| 021 | DETAIL OF INSULATION SUPPORT |
| 022 | DETAIL OF PIPE SUPPORT CLIP |
| 023 | DETAIL OF NAME PLATE |
| 024 | LOADING DATA |
| 025 | DETAIL OF DRIP RING |

According to an embodiment, the controller may determine whether an error occurs by checking an interference, placement, and scale between the nozzle, structure, and plates, and when an error occurs in the preview, a part where the error occurred may be displayed on the viewer. In this case, the controller may activate the data validation unit or the data editing unit to perform validation or editing of the engineering data. When no error occurred, the controller may control, for example, a ‘CREATE DRAWING’ button to be activated, or electronic drawings of the items constituting the tank to be automatically generated.

FIG. 2 shows an example of an electronic drawing generating unit 200 according to one or more embodiments.

The electronic drawing generating unit 200 may include a controller (not shown), a plurality of loading units 210, 212, and 214 (hereinafter, also referred to as strength calculation data loading unit 210, nozzle data loading unit 212, and relative data loading unit 214), an important data editing unit 216, a plurality of data validation units 222, 224, and 226 (hereinafter, also referred to as strength calculation data validation unit 222, important data validation unit 224, and detailed data validation unit 226), preview generating unit 250, an electronic drawing generating unit 260, and an output interface 270. The electronic drawing generating unit 200 may further include a path information providing unit 280 for displaying a path of a loaded file.

The plurality of loading portions 210, 212, and 214 may include a strength calculation data loading unit 210 for loading strength calculation data, a nozzle data loading unit 212 for loading nozzle data, and a relative data loading unit 214 for loading other relative data necessary for preparing drawings of the tank. The related data loading portion 214 may load firefighting data, previously generated engineering data sheet, and the like.

The important data editing unit 216 will be described with reference to FIG. 7. The important data editing unit 216 may include a data list unit 710, an information display unit 720, a shape providing unit 730, and firefighting data providing units 740 and 750.

When the engineering data is generated and the engineering data sheet is stored by the engineering data generating unit, the data list unit 710 may display a list of datasheets selected from among engineering data sheets as important datasheets according to a preset reference. The user may select a datasheet he/she intends to confirm from among the list of datasheets. Referring to FIG. 7, when the user wants to confirm important data from the ‘ROOF’ sheet, the ‘ROOF’ button 711 may be selected and activated. When the ‘ROOF’ button 711 is activated, the important data information of a preset reference in the ‘ROOF’ sheet constituting the engineering data sheet may be displayed on the information display unit 720. In addition, when there is related shape data, the shape data may be displayed on the shape providing unit 730. The user may confirm data displayed on the important data editing unit 216 and then correct and supplement the data.

The plurality of data validation units 222, 224, and 226 may include a strength calculation data validation unit 222, an important data validation unit 224, and a detailed data validation unit 226. The strength calculation data validation unit 222 is described with reference to FIG. 1. The important data validation unit 224 may validate the data displayed on the important data editing unit 216 as shown in the example of FIG. 8.

When correcting data that is not validated by the strength calculation data validation unit 222 or the important data validation unit 224, the detailed data validation unit 226 may correct the data by opening the engineering data sheet as shown in the example shown in FIG. 9. Other configurations are described with reference to FIG. 1.

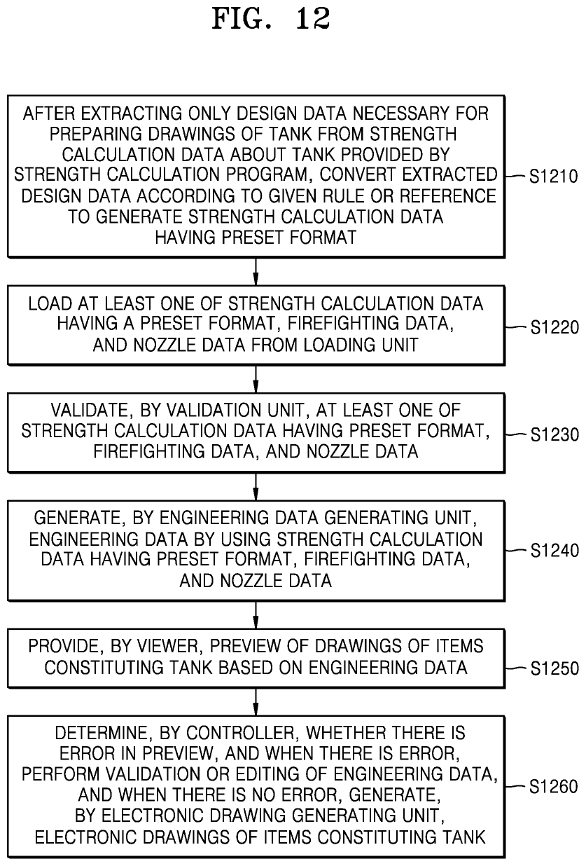

FIG. 12 is a flowchart illustrating a method of generating electronic drawings according an embodiment.

In an electronic drawing generating unit, the preprocessing unit may extract design data necessary for preparing drawings of the tank from the strength calculation data about the tank provided by a strength calculation program, convert the extracted design data according to a given rule or reference, and generate the strength calculation data having a preset format (S1210). The loading unit may load at least one of the strength calculation data having a preset format, the firefighting data, and the nozzle data (S1220). Thereafter, a validation unit may validate at least one of the strength calculation data having a preset format, the firefighting data, and the nozzle data (S1230). The engineering data generating unit may generate engineering data by using the strength calculation data having a preset format, the firefighting data, and the nozzle data (S1240). The engineering data generating unit may correct the strength calculation data having a preset format, the firefighting data, and the nozzle data in the process of generating the engineering data, and the strength calculation data having a preset format, the firefighting data, and the nozzle data may be validated and corrected after the generation of the engineering data as well.

In addition, when the user activates the preview generating interface 250 (refer to FIG. 2), the viewer may provide a preview of the drawings of the items constituting the tank based on the engineering data (S1250). In this case, the display may provide a drawing list and a preview, and a preview corresponding to an item selected by the user from the drawing list may be provided.

A method of generating an electronic drawing may include: determining, by the controller, whether an error occurs in the preview, and when it is determined that an error occurred in the preview, performing validation or editing of the engineering data, and when no error occurred in the preview, generating, by the electronic drawing generating unit, electronic drawings of items constituting the tank.

The methods of the embodiments may be implemented in the form of program commands which are executable using various types of computers and may be recorded in a computer-readable medium. The computer-readable medium may include one selected from the group consisting of program commands, data files, data structures, and combinations thereof. The program instructions recorded on the medium may be specially designed and configured for the present disclosure, or may be selected from program instructions known and available to those of ordinary skill in the computer software industry.

In the device and method for automatically generating electronic drawings according to the present disclosure, users do not need to check strength calculation data directly from documents or electronic files, and manually generate drawings by directly inputting the identified strength calculation data by using drawing tools of an AutoCAD program. In addition, errors caused by missing data or the like in the process of manually generating drawings may be prevented.

In addition, a long design or drawing time necessary for users to extract drawing data piece by piece and input the extracted drawing data may be saved, and thus the overall manufacturing period may be reduced.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of generating an electronic drawing, the method comprising:
extracting, by a preprocessing unit, design data necessary for preparing drawings of a tank from strength calculation data about the tank provided by a strength calculation program, converting, by the preprocessing unit, the extracted design data according to a given rule or reference, and generating, by the preprocessing unit, strength calculation data having a preset format;
loading, by a loading unit, at least one of the strength calculation data having a preset format, firefighting data, and nozzle data;
validating, by a validation unit, the strength calculation data having a preset format, the firefighting data, and the nozzle data;
generating, by an engineering data generating unit, engineering data by using the strength calculation data having a preset format, the firefighting data, and the nozzle data;
providing, by a viewer, a preview of drawings of items constituting the tank based on the engineering data; and
determining, by a controller, whether an error occurs in the preview, and when it is determined that an error occurred in the preview, performing validation or editing of the engineering data, and when it is determined that no error occurred in the preview, generating, by an electronic drawing generating unit, electronic drawings of items constituting the tank.

2. The method of claim 1, wherein the loading unit comprises a first loading unit configured to load only the strength calculation data having a preset format, wherein, when the first loading unit is activated and the strength calculation data having a preset format is loaded, the validation unit is further configured to automatically validate the strength calculation data having a preset format.

3. The method of claim 1, wherein, in the providing of the preview, a preview generating interface is activated only after the strength calculation data having a preset format, the firefighting data, and the nozzle data are loaded and the engineering data is generated, and when the preview generating interface is activated, the preview of the drawings of the tank is provided.

4. The method of claim 1, wherein the viewer is configured to provide a preview generating interface, and the preview is provided when the preview generating interface is activated, and the controller is further configured to determine whether an error occurred by checking an interference, placement, and scale between the nozzle, structure, and plates of the preview.

5. The method of claim 1, wherein the validation unit is further configured to validate blank items, a tank implementation range, and tank retention data.

6. The method of claim 1, wherein the validation unit is further configured to validate a radius and a height of a nozzle based on the nozzle data.

7. The method of claim 1, wherein the viewer comprises:
a drawing list displaying a list of drawings of the items constituting the tank when a preview generating interface is activated; and
a shape display section displaying shapes of the items selected from the drawing list.

8. The method of claim 1, wherein the engineering data generating unit is further configured to generate the engineering data and store the engineering data in an engineering data file having a first format, and the engineering data file includes a plurality of sheets of preset items.

9. An electronic drawing generating device comprising:
a strength calculation data loading unit configured to load strength calculation data having a preset format;
a nozzle data loading unit configured to load nozzle data;
a firefighting data loading unit configured to load firefighting data;
a validation unit configured to validate the strength calculation data having a preset format, the firefighting data, and the nozzle data;
an engineering data generating unit configured to generate engineering data by using the strength calculation data having a preset format, the firefighting data, and the nozzle data;
a preview generating unit configured to provide, in a viewer, a preview of drawings of items constituting a tank, based on the engineering data;
an editing unit configured to correct an error when there is an error in the strength calculation data having a preset format, the firefighting data, and the nozzle data validated in the validation unit, and the engineering data generated by the engineering data generating unit; and
an electronic drawing generating unit configured to generate electronic drawings.

10. The device of claim 9, further comprising a preprocessing unit configured to extract design data necessary for preparing drawings of the tank from the strength calculation data about the tank provided by a strength calculation program, convert the extracted design data according to a given rule or reference, and generate the strength calculation data having a preset format.

11. The device of claim 9, further comprising a controller configured to, when the strength calculation data loading unit is activated and the strength calculation data having a preset format is loaded, control the validation unit to automatically validate the loaded strength calculation data having a preset format.

12. The device of claim 9, wherein the viewer comprises:
a drawing list displaying a list of drawings of the items constituting the tank when a preview generating interface is activated; and
a shape display section displaying shapes of the items selected from the drawing list.

13. The device of claim 9, wherein the validation unit is further configured to validate a radius and a height of a nozzle based on the nozzle data.

14. The device of claim 9, wherein the engineering data is generated by a process of sequentially loading the strength calculation data, the nozzle data, and the firefighting data, generating sheets in the order of roof, shell, bottom, structure, nozzle, access, and appurtenances by using the loaded data, and integrating previously stored drawing list files.

15. A non-transitory recording medium recorded thereon a program for executing the method of any one of claims 1 to 8.
